(19) United States
(12) Patent Application Publication
(10) Pub. No.: US 2005/0088963 A1
(43) Pub. Date: Apr. 28, 2005

(54) Method and apparatus for protection switch messaging on a shared mesh network

(75) Inventors: Peter Phelps, Nepean (CA); Brett Caldwell, Nepean (CA); Mark Allaye-Chan, Ottawa (CA); Gary McKenna, Kanata (CA); Su Zhao, Kanata (CA)

Correspondence Address: OGILVY RENAULT, 1981 MCGILL COLLEGE AVENUE, SUITE 1600, MONTREAL, QC, H3A2Y3, CA

(73) Assignee: NORTEL NETWORKS LIMITED, St. Laurent (CA)

(21) Appl. No.: 10/691,522

(22) Filed: Oct. 24, 2003

(51) Int. Cl. H04L 1/00

(52) U.S. Cl. 370/216; 370/360

(57) ABSTRACT

A method for processing automatic protection switch (APS) messages at a network element in a tunnel provisioned across a data transport network in order to provide for distributed processing of protection switch request messages involves receiving new APS message at the NE; determining whether the NE is an end point of the tunnel, or a tandem of the tunnel and processing the message accordingly. If the NE is a tandem, message processing involves using local information about tunnel segments of the tunnel only maintained by the NE, to update the local information, and to selectively forward the updated information to adjacent NEs of the tunnel. If the NE is an end point, it updates a status of the tunnel. In a preferred embodiment all NEs are responsible for controlling pending and preemption indicators, and for initiating tunnel condition messages, and the end point NEs are responsible for initiating all other messages.

### CROSS-REFERENCE TO RELATED APPLICATIONS

This is the first application filed for the present invention.

### MICROFICHE APPENDIX

Not Applicable.

### TECHNICAL FIELD

The present invention relates to protection switching in general, and to a method and apparatus for tunnel-based protection switching on data transport networks, in particular.

### BACKGROUND OF THE INVENTION

Optical data transmission networks that have been deployed around the world, and a considerable fraction of today's data is transported over these networks. Part of the success of these networks, which include synchronous optical network (SONET) and other synchronous digital hierarchy (SDH) deployments, can be attributed to their high level of reliability. Reliability is provided by a number of protocol-based mechanisms, including failover protection.

Failover protection is well known in the art. The principle of this reliability mechanism is to provide a backup path/channel for each working path/channel, so that if one or more resources in the working path/channel fails, the traffic is rerouted over the backup path/channel. The backup path/channel, commonly referred to as a protection path/channel, preferably uses separate network resources to provide what is known as path/channel diversity. Path/channel diversity minimizes a probability that failure of a single resource (i.e. a fiber optic link, network element, or other network equipment) impacts both the working channel/path and its protection channel/path.

In SONET/SDH deployments traffic is transported in payload of a frame defined by a corresponding standard such as those well known in the art. The frame includes an overhead portion that includes an automatic protection switch (APS) channel. Known frame reception equipment is designed to handle messages sent over the APS channel with a high priority, which permits very low protection switch times (within a tens of milliseconds order of magnitude), in some networks.

It is well known in the art that the expense of providing and maintaining unused optical fiber and switching equipment is considerable. Improved protection switching schemes have consequently been developed to permit multiple working connections to ‘reserve’ respective chains of resources through a network (protection channels/paths), so that in the event of failure of a working channel/path, the failing connection can seize the reserved network resources, and establish a protection connection. Such protection schemes are known as 1:N protection schemes or shared protection schemes. A 1:N protection scheme that permits up to N working connections to share any protection resource, has been implemented on linear SONET/SDH network configurations.

In linear SONET/SDH network configurations, a NE at a downstream end of a channel that detects a failure may issue a request for protection switching by the NE at the upstream end. If the condition of the protection channel at the upstream NE indicates a higher priority occupant or request, the request from the downstream end is dropped and the other request at the higher priority is forwarded to the downstream NE, which is then obliged to cede the protection channel. Similarly, if a lower priority request for a channel is allowed before a higher priority request for the channel is received, the use of the channel is given to the higher priority requester, and the other (lower priority) channel is forced to cede the channel. Thus concurrent failures of multiple working channels are handled using a hierarchy of preemption priority values.

The preemption priority hierarchy, which may be defined in a current standard, is used at the start/end of the protection channel to ensure that a protection access policy is followed. A protection access policy may include rules such as, for example: that a signal degrade on one channel does not preempt a signal failure on another, as a signal degrade condition has less impact on traffic than a signal failure; that a manual switch can be preempted by a signal degrade, so that a manual switch does not interrupt any traffic; that a forced switch cannot be preempted by any automatic protection condition; etc.

In ring deployments of SONET, each NE is listed in a node map that is used by all of the NEs, and each NE uses network messaging to identify a priority of utilization of all of the links on the ring. While message collisions may occur because of a time it takes to notify all NEs of a change in status or occupancy of a link, all of the NEs, in principle, have complete (if sometimes slightly delayed) knowledge of the priority usage of the links, and accordingly each NE decides whether access will be granted in the event that a need arises for the protection channel/path. This NE is naturally the NE detecting the failure or receiving a network management initiated request. Linear SONET/SDH deployments are similarly equipped to perform priority-based protection switching.

In mesh-connected networks, i.e. NEs that are interconnected with arbitrary connectivity, it is generally not possible to use an equivalent to the node map. Furthermore, unless restrictions are placed on protection channels/paths, so that only whole channels/paths (i.e. end-to-end) can be shared, a problem arises when one of the channel/path segments (provided by an optical fiber link between adjacent NEs) has a changed availability because of another channel/path passing through the segment. Such restrictions would severely limit efficient utilization of protection data transport capacity.

The messaging required to enable the status of links within a tunnel to be used for priority-based preemption is problematic. Messaging time delays become increasingly difficult to manage on mesh-connected networks that permit channels of arbitrary length, and provide multiple reservations of protection paths/channels. These delays result in an increasing probability of collision, and are difficult to compensate for while maintaining low switch times. The channel/path end NE's notification of occupancy changes regarding each segment increases time delays for a number of reasons. A first reason is that notifying ends of the protection tunnels on a segment causes a backlog of messaging at a single NE. Each NE has a finite buffer space available for the APS channel, and when the buffer space is full, messages may be overwritten, leading to further problems. Secondly, the number of APS messages that need to be sent is high, resulting in a high level of occupation of the buffers of the NEs in general. As the time it takes to process and transmit an APS message is constrained by switch equipment and the APS transmission protocol, and the processing of the APS messages at the NEs is serial, the more APS messages that are sent over the APS channels of the network, the slower the protection switch time. As these protection switch times are critical to the utility of the failover protection mechanism, another solution to the problem of providing protection switching on shared mesh networks is needed. While a decision must be made as to whether or not a given protection switch request (of a given preemption priority) should be allowed or refused, no single point (NE) in a mesh-connected network has the required information to make this decision, in a timely manner.

Accordingly there exists a need for a method for enabling distributed control over network elements (NEs) of a data transport network in order to permit protection switching between channels defined across the data transport network.

### SUMMARY OF THE INVENTION

It is therefore an object of the invention to provide a method enabling distributed control over network elements (NEs) of a data transport network in order to permit protection switching between channels defined across the network.

It is another object of the invention to provide a NE of a data transport network adapted to perform a respective role in the processing of automatic protection switch (APS) messages to permit protection switching at responsive switch times, using a minimum of messaging and distributed processing of protection switch requests.

According to a first aspect of the invention, a network element (NE) of a data transport network is provided for processing automatic protection switch (APS) messages over at least one tunnel provisioned across the network. The NE includes a signal processor for maintaining a local occupancy status of a tunnel segment of the tunnel supported by a link adjacent the NE. The signal processor is adapted to use the local occupancy status and content of protection switch messages received from adjacent NEs of the tunnel to control use of data transport capacity over a link that locally supports the tunnel segment, and communicates the use of the data transport capacity to adjacent NEs of the tunnel, in protection switch messages. The NE further includes a messaging system for exchanging the protection switch messages with adjacent NEs of the tunnel enabling distributed processing of the protection switch messages across the tunnel.

The tunnel may be a bidirectional tunnel, and the messaging system is preferably a full-duplex messaging system that transmits the protection switch messages on two bidirectional links, if the NE is a tandem of the tunnel, and on one bidirectional link if the NE is an end point of the tunnel. The signal processor preferably monitors each bidirectional link for link conditions, and relays tunnel condition protection switch messages in an opposite direction of a detected link condition, if a link condition is detected at the NE, and the NE is a tandem.

The messaging system may include paired frame reception hardware and frame transmission hardware for each of the bidirectional links, for processing consecutive frames of data transported over the bidirectional link, in which case the messaging system may be provided by an automatic protection switch (APS) overhead of the frames that is presented to the signal processor with expedited interrupt-based handling.

The signal processor controls the use of the data transport capacity by inserting pended and preempted indicators in the APS messages, which are originated by end points of the tunnel. Preferably the signal processor pends a received switch request if a current occupant priority of one of the tunnel segments over which the switch request is transmitted is of an equal or higher priority than a request priority contained in the switch request, and initiates a preemption of the tunnel by inserting the preempted indicator into the APS messages in both directions, if the tunnel passing through the NE is occupied, and a successful request of a higher priority is received from another tunnel for the data transport capacity of one of the tunnel segments of the tunnel.

According to a second aspect of the invention, a method is provided for processing automatic protection switch (APS) messages at a network element (NE) in a tunnel provisioned across a data transport network. The method involves determining whether the NE is an end point of the tunnel, or a tandem of the tunnel, when a new APS message is received at the NE, and if the NE is a tandem, applying a message handling procedure for the new APS message using local information about tunnel segments of the tunnel only maintained by the NE, to update the local information, and to selectively forward the updated information to adjacent NEs of the tunnel. If the NE is an end point, the method involves updating a status of the tunnel. For example, the method may involve receiving the new APS message as one of: a notice of a link condition on a link of the NE supporting one of the tunnel segments; a tunnel condition message used to indicate the link condition to the tunnel end point; a tunnel status message from an adjacent NE received in the tunnel from a K-byte overhead of a frame that serves as a data transport unit of the network; or a message from a network management that prompts a protection switch.

If the link condition is a signal degrade on a working tunnel, the NE originating the tunnel condition may further involve forwarding a tunnel condition message in the K-byte overhead to both adjacent NEs in the tunnel; waiting for a reply to the tunnel condition messages from the end points of the tunnel via the adjacent NEs; and receiving without forwarding the signal degrade link condition messages until the tunnel condition ends, unless preempted by a signal fail.

Receiving a tunnel status message from an adjacent NE may involve receiving a protection switch request used to erect a protection tunnel; or a cede message, or a preempt message used to release a protection tunnel. The message handling procedure, upon receipt of a protection switch request message, may involve identifying an occupant priority of data transport capacity supporting the tunnel segments of the tunnel, comparing the occupant priority with a priority contained in the protection switch request to determine whether the protection switch is locally allowable, forwarding the protection switch request over the tunnel segment if the protection switch is locally allowable, and forwarding a pended protection switch request over the tunnel segment if the protection switch is locally not allowable. The comparing the occupant priority with the protection switch request priority may involve deeming the protection switch request allowed if the data transport capacity is unoccupied, and the occupant priority is consequently null, deeming the protection switch request allowable if the occupant priority is less than the protection switch request priority, and deeming the protection switch request not allowable if the occupant priority is greater than or equal to the protection switch request priority. The receiving the protection switch request message may involve receiving the protection switch request from an adjacent NE in a first direction of the tunnel, and building the cross-connect if, the protection switch request is locally allowable, any occupant is removed, and an unpended switch request is received from the tunnel, in a direction opposite the first direction. The building the cross-connect is preferably performed as soon as the switch request is deemed allowed, and if the switch request received from the opposite direction is pended, the cross connect may be taken down.

In accordance with a third aspect of the invention, a method for processing a protection switch request at a network element (NE) in a tunnel provisioned across a data transport network is provided. The method involves receiving the protection switch request, and determining whether the NE is an end point of the tunnel, or a tandem of the tunnel, and if the NE is a tandem, using an occupancy status of a tunnel segment of the tunnel only maintained by the NE, and a priority of the protection switch request to determine whether the protection switch is locally allowable. If the protection switch is locally allowable, the protection switch request is forwarded over the tunnel segment, and otherwise a pended protection switch request is forwarding over the tunnel segment. The occupancy status is preferably maintained by storing information related to use of data transport capacity that supports a local tunnel segment of the tunnel. The data transport capacity may be idle, or a tunnel segment of an occupant tunnel may be switch connected to another tunnel segment, using the data transport capacity, in which case an occupant priority of the occupant tunnel is stored. The maintaining preferably further involves monitoring the links adjacent to the NE to determine if a link providing the tunnel segment has lapsed into a link condition, and whether the NE is preempting the occupant tunnel, or pending the protection switch request.

### BRIEF DESCRIPTION OF THE DRAWINGS

Further features and advantages of the present invention will become apparent from the following detailed description, taken in combination with the appended drawings, in which:

FIG. 1 schematically illustrates a mesh network in which the invention can be deployed;

FIG. 2 schematically illustrates a division of data transport capacity on a link in the mesh network of FIG. 1;

FIG. 3 is a flow chart illustrating principal steps applied by an NE of the mesh network on receipt of a new APS message, in accordance with an embodiment of the invention;

FIG. 4 is a flow chart illustrating principal steps applied by an NE of the mesh network on receipt of a protection switch request APS message, in accordance with an embodiment of the invention;

FIG. 5 is a message flow diagram illustrating principal messages used in idle signaling along four identified tunnels of the mesh network, in accordance with an embodiment of the invention;

FIG. 6 is a message flow diagram illustrating principal messages used in failure and recovery of a link used by a tunnel of the mesh network, in accordance with an embodiment of the invention;

FIG. 7 is a message flow diagram illustrating principal messages used in an immediately allowed protection switch in accordance with an embodiment of the invention;

FIG. 8 is a message flow diagram illustrating principal messages used in a protection switch that is allowed after preemption of another tunnel, in accordance with an embodiment of the invention; and

FIG. 9 is a message flow diagram illustrating principal messages used in a protection switch that is not allowed, in accordance with an embodiment of the invention.

It should be noted that throughout the appended drawings, like features are identified by like reference numerals.

### DETAILED DESCRIPTION OF THE PREFERRED EMBODIMENT

The invention provides a messaging system and distributed processing scheme that permit protection switching on shared mesh networks.

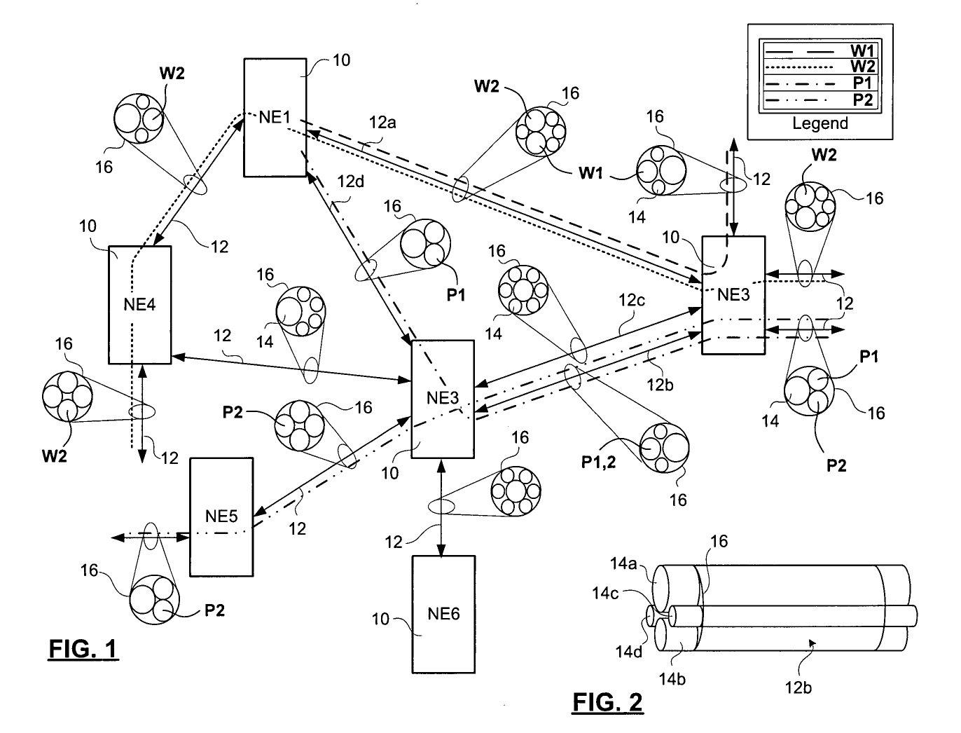

FIG. 1 schematically illustrates a portion of an optical network in which the invention may be deployed. The portion of the optical network includes six NEs 10 (NE1, NE2, NE3, NE4, NE5, NE6). The optical network is of a mesh topology. The NEs are interconnected in a generally unconstrained manner, and as such is neither a ring, nor a linear deployment. The mesh is of a bidirectional type wherein each optical fiber span that connects a first NE to a second is paired with an optical fiber span (providing equal data transport capacity) that interconnects the second NE to the first.

The NEs 10 exchange data over bidirectional (i.e. full duplex) links 12 (specific bidirectional links between the identified NEs 10 are identified as 12a,b,c,d). Each bidirectional link 12 provides a data transport capacity that involve one or more wavelength division multiplexed channels on the pair of optical fiber spans, each used for transporting data in opposite directions. In accordance with a preferred embodiment of the invention, the unit of protection switching is a tunnel. The tunnels are formed by network management operations that involve providing associated switch tables for handling the data and for directing the forwarding of overhead messaging along the resources of the tunnel. The tunnels occupy/reserve a data transport capacity that is one of a predefined portions of the data transport capacity of the bidirectional link 12 that locally supports the tunnel (i.e. provides the tunnel segment used by the tunnel). Accordingly data transport capacity 16 of each bidirectional link 12 is divided to form a number of tunnel segments 14. For simplicity, the bidirectional links 12 are shown to be of a same data transport capacity 16, and the data transport capacity 16 (schematically represented by a circular cross-section of the bidirectional link 12) is divided into tunnel segments 14, for example of ½, ¼, and ⅛ of the data transport capacity 16. For simplicity of illustration, only four of the tunnel segments 14 are identified by the reference numeral.

This division of data transport capacity on a bidirectional link 12b of FIG. 1, is schematically illustrated in FIG. 2, in which the data transport capacity 16 is schematically allocated to form a first tunnel segment 14a that constitutes half of the data transport capacity 16, a second tunnel segment 14b that constitutes a quarter of the data transport capacity 16, and two tunnel segments 14c,d that respectively constitute one eighth of the data transport capacity 16 (the reader is asked to discount the wedge shapes between the tunnels 14). It should be noted that tunnels are provisioned entities that are set up and taken down by a network management function in response to demand. Accordingly tunnel segments on a bidirectional link 12 are not expected to persist indefinitely, and any set of tunnel segments 14 may be provisioned through the bidirectional link 12, as required.

As shown in FIG. 1, two identified working tunnels: W1, and W2, are provisioned across the optical network, each having the same data transport capacity. The NE1 is an end point of the working tunnel W1; the other end point is not shown. The working tunnel W1 passes through NE2. More specifically working tunnel W1 occupies an identified tunnel segment 14 on bidirectional link 12a, between NE1 and NE2, that is switch-connected at NE2 to/from another working tunnel segment 14 of another bidirectional link 12. The working tunnel W2 has two end NEs 10 that are not illustrated, and passes through NE4, NE1 and NE2, occupying identified data transport capacity on a bidirectional link 12 of NE4, identified data transport capacity on a bidirectional link 12 between NE4 and NE1, identified data transport capacity on bidirectional link 12a, and identified data transport capacity on bidirectional link 12 connected to NE2.

Each of the working tunnels W1, W2 has a corresponding protection tunnel; respectively P1, P2. The protection tunnel P1 has reserved data transport on the bidirectional link 12d, which extends from NE1 (one end of the tunnel), and through NE3. P1 further reserves data transport capacity on bidirectional link 12b between NE3 and NE2, and on another bidirectional link 12 connected to NE2. Protection tunnel P2 reserves corresponding data transport capacity on bidirectional links between a first end and NE5, NE5 and NE3, NE3 and NE2 (i.e. bidirectional link 12b), and between NE2 and its second end. The tunnel segment 14b reserved for protection tunnel P2, is also reserved for protection tunnel P1. This multiplicity of reservation is permitted in a 1:N protection scheme, wherein each working tunnel can “share” any part of its protection path, with up to N other working tunnels. It should be noted that while a working tunnel “occupies” its tunnel segments 14, a protection tunnel merely “reserves” the tunnel segments 14.

It is a characteristic of revertive protection schemes, that once a working tunnel is switched to a protection tunnel, and the reason for switching (usually a condition of the working tunnel that led to a request for protection switching, or a network management requested switch) is removed, the protection tunnel is de-selected and the occupation of the protection tunnel is ceded. More specifically, if a network management request for switching to a protection path is received, it is followed by a release, at which point the protection path is released. If a protection switch is requested in response to a working tunnel condition, generally a predefined wait to restore time elapses before reverting to the working path. The wait to restore time provides the recovering working tunnel with a test period in which it is determined if the failure will recur (or the failure was not remedied), to reduce protection switch request messaging that would otherwise be necessary. It will be evident to those skilled in the art that the messaging and processing involved in a protection switch request are considerable, and protection switching, reversion and protection switching again is a resource intensive alternation. The wait to restore time is a well known solution to this problem. While the present invention is independent of such protection scheme electives, it shall be described herein with reference to a revertive protection scheme.

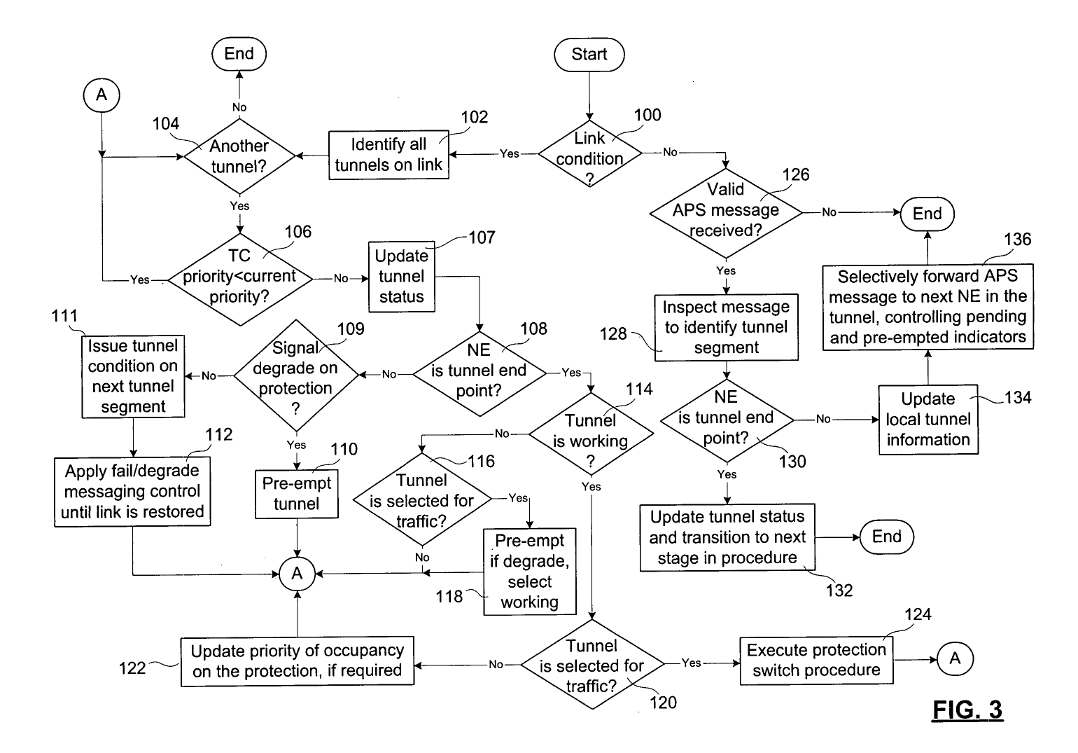

FIG. 3 schematically illustrates a process applied by any NE 10 of the network illustrated in FIG. 1 to permit the cooperation of the NEs 10 to enable a distributed procedure for failover protection. Specifically FIG. 3 shows some of the processing applied at an NE, in response to a change in an APS message on a link. It is first determined whether the APS message indicates a link condition. If, in step 100, it is determined that a link condition (such as a signal failure or a signal degrade) has been detected, in step 102, the NE identifies all of the tunnels on the link (that has the detected link condition). The manner in which a signal failure/signal degrade is detected on a link in a data transport network is well known in the art, and generally is intended herein to include both (line) alarm indication signals (AISs) detected by frame reception equipment in the direction of the failure, and (line) remote defect indications (RDIs) that are automatically inserted into a transmitter that is paired with frame reception equipment that received the AIS, and therefore is received at the other end of the failed tunnel segment, traveling in an opposite direction.

If there are no (more) tunnels identified on the link (as determined in step 104), the process returns to step 100. Otherwise (in step 106), it is determined whether a current occupant/link condition is of a higher priority than a link condition on the tunnel. If a higher priority link condition or occupant already exists on the tunnel, the current link condition is not signaled to a tunnel adjacent NE, and the procedure returns to step 104 to handle a next tunnel. Otherwise tunnel status information is updated (step 107) and it is determined whether the NE is an end point, or a tandem NE, of the identified tunnel (step 108). If the NE is not the end point, it is determined whether the tunnel is a protection tunnel, and whether the link condition is a signal fail or a signal degrade (step 109). If both of these conditions are met, the NE applies a preemption procedure to force the protection tunnel to relinquish the tunnel segment, as the tunnel segment has a lower occupant priority than the locally identified link condition (step 110). Otherwise the locally identified link condition on a working or protection tunnel is converted into a tunnel condition message sent in an APS message on a corresponding tunnel segment of the tunnel that is switch connected to the identified tunnel segment (step 111), so that in a hop-by-hop manner, the tunnel condition is propagated to the end points of the working or protection tunnel. If the link condition is a signal degrade, corresponding message control procedures are applied so that the signal degrade tunnel condition messages are terminated by the NE when received (step 112). This is required if, for example, a reply to the tunnel condition message received at an end NE indicates that the tunnel condition has cleared. In either case, the NE is set to issue messaging used to indicate that the tunnel is cleared (see FIG. 6), when the link is repaired.

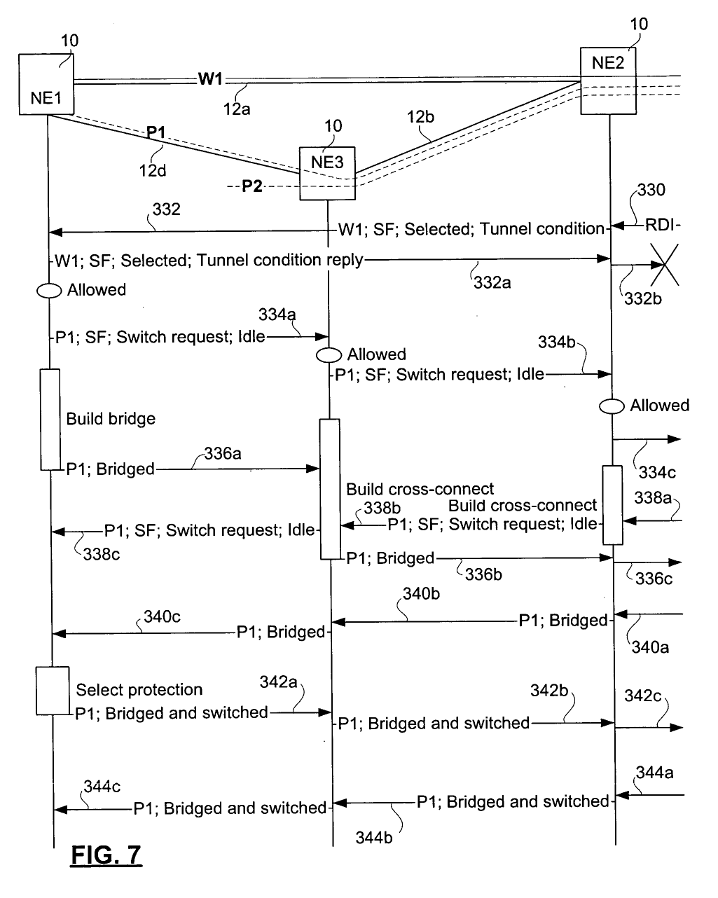

It may be determined in step 108 that the NE is an end point of the tunnel, in which case the tunnel is determined to be either a working tunnel or a protection tunnel (step 114), and is further determined to be selected or idle (step 116, or 120). Herein a tunnel is selected if it is carrying the traffic that exits the tunnel at one of the tunnel end points. In accordance with the embodiment chosen for illustration, the working tunnels are always carrying the traffic (at least between an end point and a signal failure), but when a protection tunnel is bridged (described further below with reference to FIGS. 7,8), the traffic is transmitted over both the working and protection tunnels. When a protection tunnel is bridged and switched, the traffic exiting the tunnel is taken from (i.e. selected) the protection tunnel.

If the tunnel is found to be a protection tunnel, and the traffic is idle on the protection tunnel, the link condition has had no impact on any traffic. In such a case the NE will wait to receive a message indicating that the tunnel condition of the protection tunnel has cleared, before changing the tunnel status (set in step 107) and making it possible to admit a protection switch request for the protection tunnel. Accordingly the process returns to step 104.

If the tunnel is a protection tunnel that is selected (i.e. bridged and switched), the end point returns traffic to the working tunnel, regardless of a condition of the working tunnel. The reversion to working (step 118) involves deselecting the protection tunnel, and changing the current message on the protection tunnel to indicate a signal failure, or a signal degrade. If the link condition is a signal degrade, the end NE will issue a preemption message to a previous NE in the protection tunnel. The preemption message will be forwarded along the protection tunnel to the opposite end NE, and cause a release of the tunnel. If the link condition is a signal failure of the protection tunnel, the tunnel condition reply may not be received at the next NE in the protection tunnel, as the message field is overwritten with a remote defect indicator, or is obstructed by the tunnel condition.

If the identified tunnel is found to be a working tunnel that is idle, the working tunnel might have already been in a tunnel condition, or the working tunnel may have been switched to protection by a network management initiated request. In any case, the corresponding protection tunnel that is selected to transport the traffic occupies respective tunnel segments at an occupant priority that may be antiquated. So while the link condition has had no effect on the traffic, there may be a need to change a priority of the occupation of the protection tunnel; this updating being performed in step 122. For example, if a preemption priority hierarchy as define in co-applicant's co-pending U.S. patent application Ser. No. 10/662,400, filed on Sep. 16, 2003, entitled METHOD AND APPARATUS FOR PROVIDING GRADES OF SERVICE FOR UNPROTECTED TRAFFIC IN AN OPTICAL NETWORK, and is incorporated herein by reference, is used, and the current occupant priority value of the protection tunnel is either a wait to restore, or a manual switch, the signal failure or signal degrade is of a higher priority, and accordingly the end NE will update a priority of the protection tunnel. This updating of the priority is important for preventing the preemption of the protection tunnel. Once the current occupant priority value is updated (or updating is determined not to be necessary), the process returns to step 104.

If the tunnel in the identified tunnel condition is a working tunnel that is selected to transport traffic, the tunnel condition has impacted traffic. Accordingly a protection switch procedure is executed (step 124). The protection switch procedure involves identifying a protection tunnel associated with the working tunnel, and accessing a status of the protection tunnel segment adjacent the NE in order to determine whether a protection switch request is locally allowable. If the protection switch is locally allowable, a switch request message is issued to a next NE in the protection tunnel. Otherwise a pended switch request message is sent. This procedure is further described below with reference to FIGS. 7,8. The procedure returns to step 104.

If, in step 100, no link condition is present according to the APS message, it is determined if a valid automatic protection switch (APS) message has been received. As will be appreciated by those of skill in the art, a change in the APS message on a link indicates that a tunnel on the link (i.e. a protection tunnel reserving or occupying a tunnel segment of the link, or a working tunnel occupying a tunnel segment) has a changed status. Validation of APS messages may involve forward error correction or a validation by repetition scheme, well known in the art. The different status may be an indication of a tunnel condition, a change in a state of occupation of a tunnel, a change in a request priority value associated with a tunnel usage, etc. In any case, the APS message is inspected to determine a tunnel segment identified in the APS message. More specifically, an index locally associated with a tunnel that reserves/occupies identified data transport capacity is read. An example of a format for the APS message is described in detail in co-assigned, co-pending U.S. patent application Ser. No. 10/662,314, filed Sep. 16, 2003, entitled K-BYTE EXTENSION AND TUNNEL IDENTIFYING SCHEME FOR TUNNEL-BASED SHARED MESH PROTECTION, and incorporated herein by reference.

Once the tunnel is identified, it is determined whether the NE is a tunnel end point (step 130), or a tandem NE of the identified tunnel. If the NE is a tunnel end point, the APS message is used to indicate a change in the state of, or a request for, the tunnel. As will be evident to those of skill in the art, the end point processing of such APS messages and the consequent actions taken by the NE will depend on a state in a procedure applied by the NE, and previous messages. For example, a procedure for requesting a protection switch may involve a number of stages, associated with respective APS messages. Frequently the APS messages will indicate that a corresponding stage has completed. The NE will therefore take the actions required in accordance with program instructions, and the condition of the tunnel inferable from the received APS message (step 132).

If the NE is a tandem in the identified tunnel, the NE updates a local status of the tunnel (step 134). Such information as is required to correlate messages received at the NE from opposite directions of the tunnel, are required to perform some operations, and are therefore maintained. The tandem NE has a role in some operations and is generally responsible for setting pended, and preempted indicators in the APS messages, and performs local procedures for controlling a switch fabric, etc. Accordingly the NE selectively forwards the received APS message to a next NE in the tunnel (step 136), and may modify the message by either setting a preempted indicator, or setting a pended indicator, depending on information only available at the NE regarding the tunnel segment of the NE.

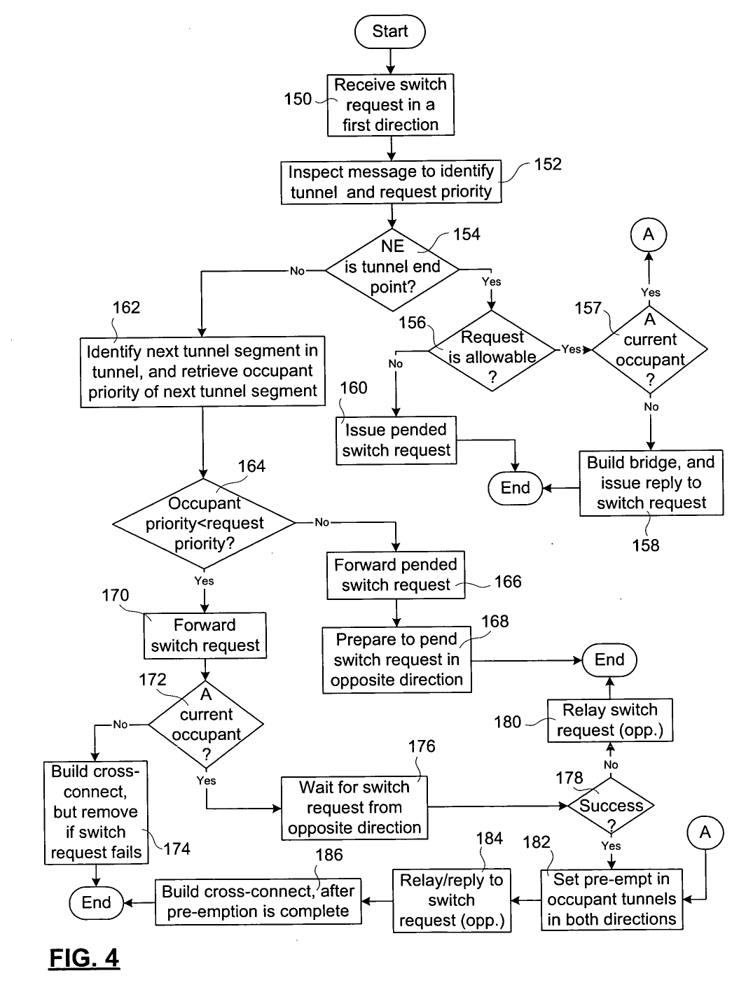

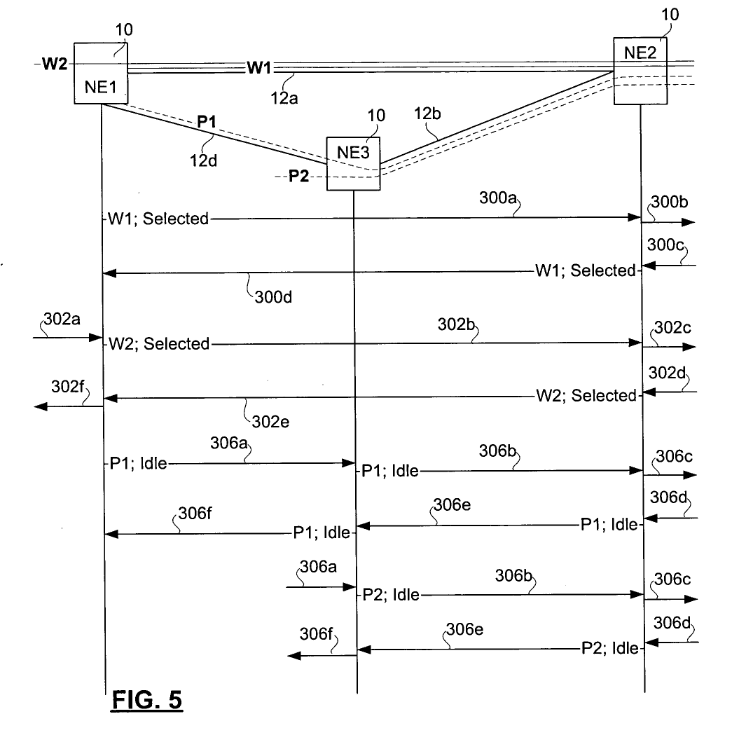

FIG. 4 is a flow chart illustrating handling of a protection switch request APS message on a protection tunnel at any NE 10 of a mesh network, in accordance with an embodiment of the invention. Because the switch request is a type of APS message most directly associated with the protection switching, it is further described. A tandem NE of a bi-directional tunnel will have APS messages flowing in both of two directions, and frequently correlation of APS messages in both directions is required to correctly determine a state of the tunnel segment. Generally a switch request is received in one direction (i.e. the first direction) before the other. The switch request is received in the first direction (step 150), and is inspected by the NE. The NE determines which of the tunnels provisioned across the NE is the tunnel along which the switch request is sent (step 152), and obtains a request priority value included in the request.

When the tunnel is identified, the NE obtains (step 154) either an identification of a next tunnel segment of the tunnel (in the first direction), and either the corresponding data transport capacity associated therewith, or an indication that it is an end point of the tunnel. If the NE is an end point, it is verified that the data transport capacity on the link over which the switch request was received, is available to support the requested switch. While the previous NE in the tunnel (which forwarded the switch request) will have already determined that the protection switch is allowable on that data transport capacity, the end point NE must also verify that it is allowable, to avoid mistakes caused by an incorrect record of the use of the data transport capacity. If an occupant priority of the data transport capacity is less than the request priority of the switch request, the switch request is allowable (step 156). If the switch request is allowable, it is determined (step 157) whether or not the data transport capacity is currently occupied. If the data transport capacity is currently occupied the procedure advances to step 182, where the occupying tunnel is preempted. Otherwise a reply to the switch request is returned to the adjacent NE in the tunnel (step 158), and the NE bridges a working tunnel identified by the protection tunnel, with the protection tunnel.

If the switch request is not allowable according to the end point NE, a pended request reply message is returned by the NE (step 160). A pended request is issued when an NE determines that a received protection switch request cannot be granted or completed and therefore remains in a wait (pended) state until it can be granted or the request priority is cleared.

If, in step 154, it is found that the NE is a tandem, the NE identifies a next tunnel segment of the tunnel, and retrieves an occupant priority of the data transport capacity that supports the next tunnel segment (step 162). If the occupant priority is greater than or equal to the request priority (as determined in step 164), the switch request is not allowable and accordingly the NE forwards the switch request inserting a pended indicator (step 166), so that effectively a pended request is relayed over the next tunnel segment. When the switch request is received in the opposite direction, that switch request will be likewise pended (step 168).

Otherwise the occupant priority is less than the request priority (determined in step 164), and the tandem NE forwards the switch request over the next tunnel segment (step 170). The tandem NE then determines if the occupancy is a null priority, indicating that the data transport capacity is idle (step 172). If the data transport capacity is idle, the NE builds a cross-connect to locally build the tunnel (step 174). This cross-connect is taken down if the switch request fails for any other reason. In particular, if a pre-empted or a pended bit is set on the switch request in the opposite direction, a collision has occurred, or another NE in the tunnel has deemed the switch request not allowable, respectively. A further reason for releasing the cross-connect would be that a tunnel condition is issued.

If an occupant is identified on either of the two tunnel segments local to the tandem NE, the occupant is not preempted until it is determined that the protection switch request is a success (i.e. that no NE in the tunnel has pended or preempted it). Accordingly the NE waits until a switch request is received from the opposite direction (step 176), without a pending or preemption indicator set. If it is found in step 178 that the switch request in the opposite direction is either pended or preempted, the switch request is not a success, and the switch request (with the pended or preempted indicator set) is relayed to a next NE of the tunnel, in the opposite direction (step 180).

Otherwise the switch request is a success, and the NE must preempt the occupant. This is accomplished by setting a preemption indicator on the occupant tunnel so that in each direction (two directions if the NE is a tandem of the occupant tunnel, one otherwise) of the occupant tunnel (step 182), the preempted indicator is set, and accordingly the preempted message is forwarded to both end points of the occupant's tunnel. If the occupant is extra traffic, or an unprotected traffic of some priority (as described in the aforementioned METHOD AND APPARATUS FOR PROVIDING GRADES OF SERVICE FOR UNPROTECTED TRAFFIC IN AN OPTICAL NETWORK application), known methods for removing the extra traffic are applied. Once the messages that initiate the preemption have been sent, the NE relays the switch request in the opposite direction (step 184). It will be noted that if the NE is the tunnel end point, the switch request is in the form of a reply. Accordingly, when the preemption is complete, the cross-connect is built to support the tunnel, and the handling of the protection switch request message ends (step 186).

To illustrate processing of the APS messages at NEs collectively, message flow diagrams 5-8 are described below.

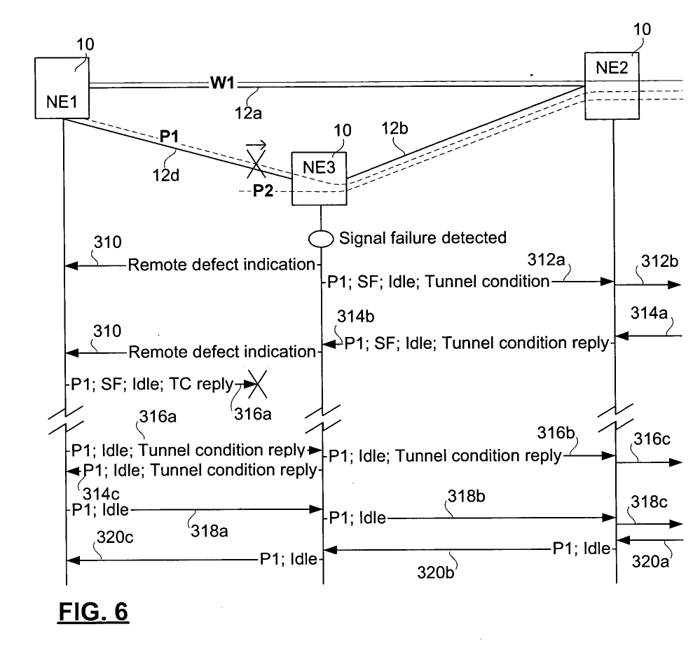

FIG. 5 schematically illustrates idle messages exchanged over a part of the illustrated part of the network shown in FIG. 1. Corresponding parts of tunnels W1,2, P1,2 are also shown. In accordance with the invention, the APS messages follow a switch connected path through the NEs 10, over the links 12, between end points of the tunnels. As the tunnels are bidirectional, messages are sent between the end points in both directions. Messages are exchanged over both protection and working tunnels. The part of the network shown includes NE1, which is the end point of W1 and P1, and is a tandem of W2. The other two NEs, NE2, and NE3, are tandems of W1,W2,P1,P2 and P1,P2, respectively. It is assumed that both P1 and P2 share a tunnel segment on link 12b.

Each NE 10 stores a current APS message for each respective tunnel, but the APS messages are not repeated in each successive frame. The APS messages of FIG. 5 may be last messages sent over the respective tunnels, when the network is in a usual operating state, or may be sent to refresh the stored current APS messages of the NEs 10. In some embodiments messaging is issued end-to-end at a predefined frequency, for example to maintain tunnel-related information, detect silent failures, etc. Accordingly at a predefined frequency (possibly in the order of minutes) each end NE of a tunnel issues a corresponding message indicating a status of the tunnel (i.e. re-issues the last message sent). If the last message sent was the last re-issued message, the hardware may send a null message first to ensure that the re-issued message is detected by the next NE, which may otherwise be designed to ignore re-issued messages.

It is assumed that the working tunnels (W1,2) are selected for transporting data, and accordingly, along W1, a selected message 300a,b,c,d is forwarded. The selected message does not indicate that a tunnel condition exists, although if a link supporting W1 were to lapse into a link condition, the corresponding NE would issue a tunnel condition message in lieu of whatever message is currently in effect on the next link. The selected message 300a is transmitted over link 12a, received by NE2, and selected message 300b is forwarded over a next link 12 to a next NE of W1. In a hop-by-hop manner, the selected message 300 makes its way to an end point of W1 (opposite NE1), and similarly the selected message 300 is relayed in the opposite direction along W1.

It should be noted that in some embodiments the APS messages are continuously being transmitted between each pair of NEs in the tunnel. In accordance with synchronous optical network (SONET) and other synchronous digital hierarchy (SDH) deployments, each successive frame used to transport data has an overhead field that includes a reserved space for APS messages, and each such frame contains a valid bit pattern, in accordance with a pre-established protocol. Typically the bit pattern is held constant in successive frames, unless there is a change in the tunnel's status. In the event of a change, the tunnel is said to send a message to indicate the change by issuing a different bit pattern in the overhead that provides the APS channel. However, in accordance with the illustrated embodiment, a plurality of tunnel segments of predefined proportions of the data transport capacity can be concurrently provisioned across the links. This means that while a valid bit pattern must be found in the overhead portion of each frame, the bit pattern is identified with only one portion of the data transport capacity, and only one of the protection tunnels that may jointly share a protection tunnel segment if the portion of the data transport capacity is for protection. A definition of the overhead that is sufficient for identifying tunnel segments, and to provide the required message status information is provided in the above referenced application entitled K-BYTE EXTENSION AND TUNNEL IDENTIFYING SCHEME FOR TUNNEL-BASED SHARED MESH PROTECTION.

Similar selected messages 302a,b,c,d,e,f are sent between the NEs of W2. These are received and forwarded in the same manner as selected messages 300.

As the tunnel W1 is selected, its protection tunnel (P1) is reserved, but is not switch-connected to form a traffic conduit. Nonetheless APS messages are still relayed along P1 in substantially the same manner as the selected messages are transmitted over W1,2, the APS messages containing an identifier of the respective tunnel segment and the tunnel of which the tunnel segment forms a part. Idle messages are sent from P1 end point NE1 to NE3 304a, and relayed from there to NE2 304b, and onwards toward an opposite end point of P1 304c. From the opposite end point similar messages 304d,e,f are propagated, hop-by-hop.

Similar idle messages 306a,b,c,d,e,f are sent between the NEs of P2. Only NE2, and NE3 of the illustrated drawing are a part of P2.

FIG. 6 schematically illustrates principal messages involved in detecting a signal failure, and recovery messaging after the signal failure clears. The current example involves a failure on bidirectional link 12d in a direction from NE1 to NE3, which does not impact any traffic, as P2 (the only provisioned tunnel on the link) is idle, as per a state of the network described in FIG. 5.

The signal failure is detected at NE3, and hardware at NE3 automatically inserts a remote defect indication (RDI) 310 in the APS channel of the overhead of the frames transmitted over the optical fiber span paired with the failed optical fiber span, (the two optical fiber spans constituting the bidirectional link 12d). It will be noted that even if the RDI fail to be issued for one reason or another, the failure will still be detected by an opposite end point, and a (slower) single sided switch request will follow. Both the NE3 and NE1 consequently identify all tunnels on the link 12d, and issue tunnel condition messages along each. Accordingly, the NE3 assert an idle message identifying P1, including an indicator that a tunnel condition (signal failure) exists on the identified tunnel 312a. Normally a tandem only controls setting and unsetting of pending and preemption bits, however, if a signal fail tunnel condition is detected, the tandem will originate an APS message. The tunnel condition message 312b is forwarded hop-by-hop towards an opposite end point (not shown) of P1. The opposite end point issues a reply to the message and updates a status of the tunnel. The reply is forwarded hop-by-hop and arrives at the NE2 314a. This is relayed to NE3 314b, and would be forwarded to NE1, were it not for the RDI 310 that persists on the link 12d, and which overwrites whatever APS message is expressed on the APS channel. The NE1 performs substantially the same operations as the opposite end point; updating the status and issuing a reply 316a. Of course the optical fiber span is inoperative and the reply 316a issued by the NE1 is not received by NE3.

After some time, the problem that caused the signal failure is fixed, and a diagnostic procedure is applied at each end of the bidirectional link 12d, concluding in transmissions of the reply 314c from the opposite end point, and the reply 316a from the NE1. The reply 316a received at NE3 is relayed as reply 316b to NE2, and beyond that the reply 316c is relayed hop-by-hop to the opposite end point. Meanwhile the NE1 has received the reply 314c, and consequently updated its status of the tunnel to ensure that future requests may be allowed. It should be noted that any protection switch requested from W1 (or network management) at NE1 between a time when the RDI 310 was first received, and when the tunnel condition reply 314c is received, is refused (i.e. pended if a signal degrade or a signal fail is detected on working). The NE1 then issues an idle message 318a that indicates that no tunnel condition is evident. The idle message is propagated to NE2, and onwards in messages 318b,c respectively. Likewise the opposite end point receives the tunnel condition reply 316c, updates its status, and issues an idle message 320, which is forwarded to the NE2 320a, NE3 320b, and back to end point NE1 320c. In the conclusion of FIG. 6 the NEs of the tunnel are all in agreement that the protection tunnel P1 is operational and idle.

FIG. 7 shows principal steps involved in a protection switch request from W1 to P1 that is immediately allowed by all NEs of the tunnel P1. A RDI 330 is received at NE2 indicating that a link 12 supporting W1 between NE2 and a next NE of W1, has failed in a forward direction (from NE1). The NE2 therefore inserts a tunnel condition into an APS message 332 directed to NE1. NE1 then issues the reply 332a which is relayed by NE2 332b, but does not arrive at the next NE 10 in W1, because of the signal failure.

The NE1, upon receipt of the tunnel condition message, identifies W1's protection tunnel (P1). It determines an occupancy of the tunnel segment on link 12d that is reserved by W1 (i.e. is a part of P1). It is found that the associated data transport capacity is idle, and accordingly the use of the tunnel segment is allowed to the NE1.

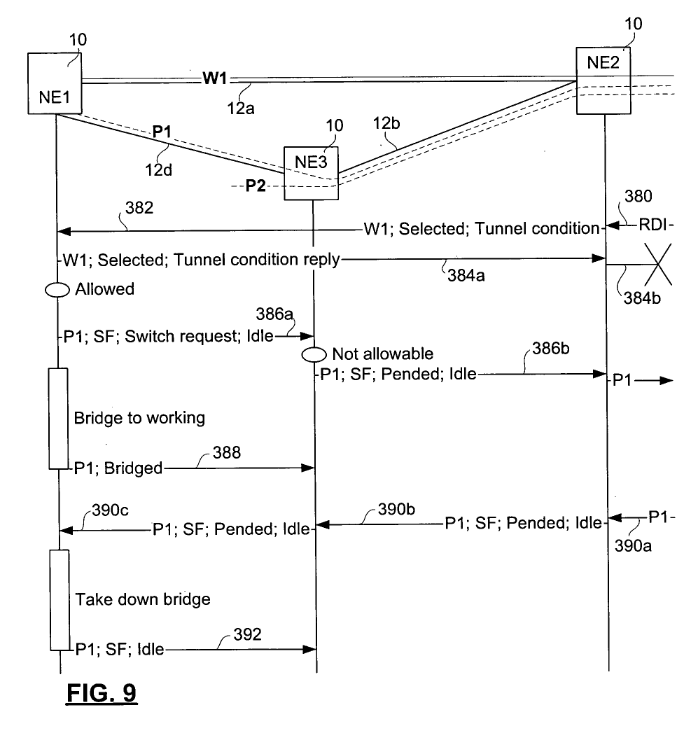

In accordance with the illustrated embodiment of NE processing, a switch request (either received in an APS message or internally generated by an end point NE) can be handled in one of three ways, depending on a priority of the switch request, and possibly a priority of an occupant of the data transport capacity in question. A hierarchy of preemption priorities are used to determine whether to pend a request or preempt an occupant (a suitable priority hierarchy is described in the aforementioned application entitled METHOD AND APPARATUS FOR PROVIDING GRADES OF SERVICE FOR UNPROTECTED TRAFFIC IN AN OPTICAL NETWORK). If the data transport capacity in question is unoccupied, the NE will deem the request allowed, and begin establishing a cross-connect through a switch fabric of the NE to permit traffic to be conveyed over the protection tunnel. If there is an occupant of the data transport capacity with a higher priority than that of the request, the request is refused by setting a pended indicator in the switch request message and forwarding the pended message (see FIG. 9). If an occupant has a lower priority, the occupant may be preempted, but before such preemption, the NE ascertains whether the protection switch request is allowable by all of the other NEs in the protection tunnel. This is the scheme chosen for the illustrated embodiment of the invention, although the invention could be deployed using other rules.

As the protection switch request is allowed, the NE1 sends a protection switch request 334a over the identified tunnel segment to a next NE of P1 (NE3), and begins building a bridge from the working tunnel to the protection tunnel. The bridge will cause the traffic to be transported over the identified tunnel segment as well as W1. The switch request 334a includes an identifier of the tunnel segment of P1, and a request priority value that, in this case, is associated with a signal failure (SF) that is used at each of the tandem NEs to determine whether to preempt the current occupant, or to pend the request. If the request priority value is greater than a priority value of the occupant, the occupant is preempted, (or dropped if the occupant is extra traffic, as described in the aforementioned application).

Upon receipt of the switch request 334a, NE3 identifies a next tunnel segment of P1, and accesses a state of occupation of the associated data transport capacity. It is found that the data transport capacity (of link 12b) is idle, and so NE3 allows the request. Consequently, a switch request 334b (that includes the same request priority and identifies P1) is issued to NE2, and a cross-connect is built to switch traffic between the identified tunnel segment on link 12d, and that on link 12b. Upon receipt of the switch request 334b, the NE2 performs the same switch request handling procedure as NE3, and forwards a switch request 334c to a next NE of P1, as the next tunnel segment of P1 is idle. In this manner the switch request 334 is propagated to an end point of P1 opposite NE1. Each of the tandem NEs that has allowed the request builds a cross-connect in order to erect P1, effectively taking P1 from a locally reserved status to a locally occupied status.

Each NE in the protection tunnel is responsible for sending a bridged message to a next NE in the tunnel once 1) it has completed its cross-connect, and 2) a bridged message is received from a previous NE in the tunnel. The end point NE1 issues a bridged message 336a after its bridge is completed. The NE3 must wait until its cross-connect is built before it forwards a bridged message 336b to NE2. The NE2 does not forward the bridged message 336b to the next NE (336c) until bridged message 336b is received at NE3, despite the fact that the NE2 had already completed building the cross-connect.

Normally the opposite (to NE1) end point will have received a tunnel condition message from an other side of the signal failure before the switch request 334, and accordingly it will have already determined occupancy of an adjacent tunnel segment of P1, and issued the switch request message 338. Otherwise the opposite end point issues a reply to the switch request, the reply being treated by the tandems substantially the same as a switch request issued from the opposite end point. The switch request message 338a is forwarded to NE2, from there to NE3 (338b), and finally to NE1 (338c). Upon receipt of the switch request 338, NE1 has confirmation that the protection switch has been allowed by all of the NEs in P1. In the illustrated example, it happens that the switch request messages 338 intersect the bridged messages 336 at NE3.

As the NEs (not shown) on the other side of P1 perform the same procedures, eventually all of the NEs between NE2 and the opposite end point have completed corresponding cross-connects. Accordingly, a bridged message 340a will be received at NE2. This message is relayed as bridged message 340b,c to NE3 and NE1, respectively. The bridged messages 340b,c are relayed immediately because the cross-connects are built.

When NE1 receives the bridged message 340c, it is confirmed that P1 (in the direction coming from the opposite end point) is bridged, and accordingly the traffic is flowing on P1. NE1 then selects the traffic on P1 to exit the tunnel. The opposite end point does the same upon receipt of the bridged message 336. To make sure that all NEs are notified that the traffic they are transporting is live, and to verify that the opposite end has received the bridged message 336 (and vice versa), bridged and switched messages 342,344 are transmitted by both the end points after the selection of the protection is applied. Specifically, bridged and switched messages 342a,b,c are forwarded to NE3, NE2, and onward toward the opposite end point, respectively in the same hop-by-hop manner as before. Likewise, in the opposite direction, bridged and switched messages 344a,b,c are forwarded to NE2, NE3, and NE1, respectively.

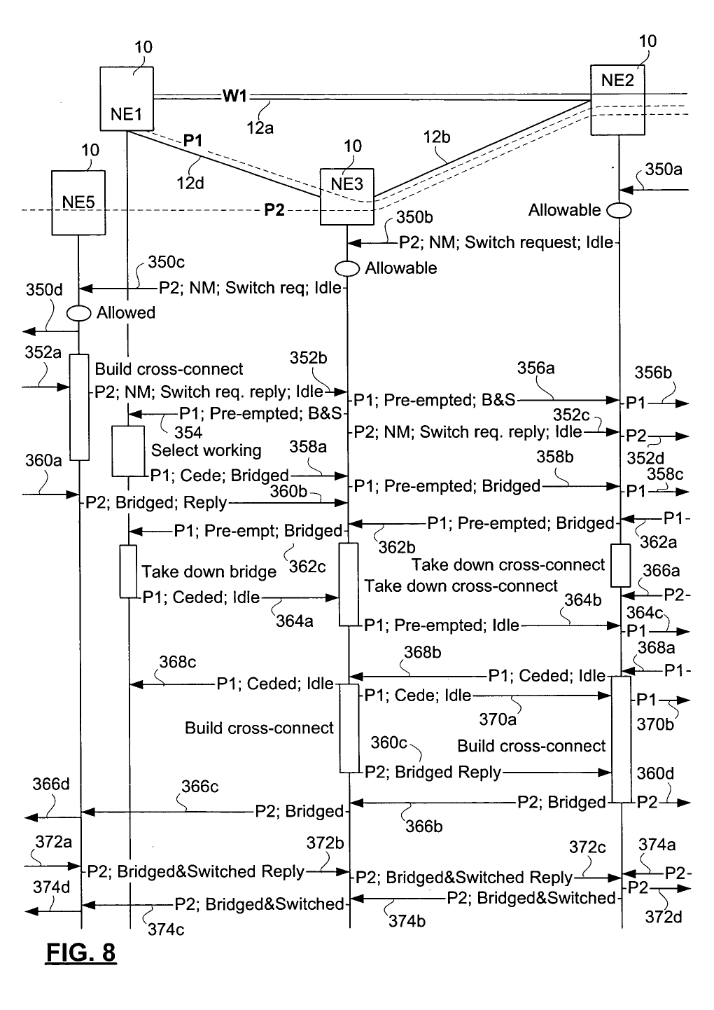

Assuming that the network is in a state consistent with the conclusion of FIG. 7, FIG. 8 illustrates principal steps involved in another protection tunnel (P2) preempting P1's use of the tunnel segment between NE2 and NE3. Generally protection switch requests are of one of two kinds, automatic protection switch requests resulting from the link conditions (as described above), and network management initiated requests. Generally, network management initiated requests are issued to only one side of the tunnel, and accordingly one-sided processing is applied, whereas, in general, both end points receive the tunnel condition messages during automatic protection switch processing.

A requesting (right as illustrated) end of P2 receives the network management (NM) switch request and accordingly performs a now familiar process of identifying the adjacent protection tunnel segment, determining a current occupancy status thereof, and issuing a protection switch request message 350 thereover. It is assumed that all of the NEs of P2 at the requesting end deem the switch request 350 allowable, if not allowed, and accordingly none have set a pended indicator in the switch request 350, to turn the message into a pended message. NE2 therefore receives from the requesting end of P2 the switch request 350a and determines that the request is not immediately allowed, as P1 currently occupies the identified protection data transport capacity. Rather, as a request priority of the network management switch request is higher than that of P1, (for example the NM switch request may correspond to a forced switch as described in the aforementioned co-pending application) the switch request 350a is allowable. The switch request 350b is then forwarded to NE3, which determines that while the next tunnel segment is idle, the previous tunnel segment is occupied, and consequently finds that the protection switch is allowable. NE3 forwards switch request 350c to NE5, which allows the request, begins building a cross-connect, and forwards the switch request 350d toward a responding end point of P2 (to the left of the NE5 as drawn).

As the switch request 350 is one-sided, the responding end point receives the switch request 350, and issues a reply 352, which is forwarded hop-by-hop to arrive at the NE5 (352a). It happens that the reply 352a arrives before NE5 completes the cross-connect. The NE5 immediately forwards the reply 352b to NE3. Now NE3 has confirmation that the NEs of the respecting side of P2 find also that the protection switch is allowable. Accordingly P1 has to be preempted in order to permit access to the protection tunnel segment on link 12b. In the illustrated embodiment, the preemption messages 354 and 356a are issued prior to forwarding the reply 352c, so that any NE on the requesting side of the NE3 that shares a tunnel segment between P1 and P2, is notified of the preemption of P1, and does not have to initiate the preemption of the same tunnel.

The preemption sequence on P1 begins at NE3, which inserts the preemption identifier into APS messages of the P1 tunnel in both directions. Accordingly, a bridged and switched message with the preemption indicator set 354, is sent in a reverse direction to NE1 (which happens to be the end point), and a preempted bridged and switched message 356a, is forwarded to NE2, and from there toward an opposite (to NE1) end point of P1 (356b). The reply 352c is forwarded to NE2 after the preempted bridged and switched message 356a, and from there is forwarded (352d) to the requesting end of P2.

The NE1 receives the preemption indicator in the bridged and switched message 354, and deselects the P1 in favor of W1. W1 may be in a tunnel condition, and accordingly the traffic may be thereby effectively dropped. (For simplicity the ensuing message sent over W1 is not -shown.) Once the protection is deselected, the NE1 issues a cede message 358a indicating that the tunnel is bridged. The cede message 358a may be a bridged message that has a null priority, for example. Upon receipt of the cede message 358a, NE3 sets the preempted indicator and forwards the preempted cede message 358b to NE2. NE2 relays this preempted cede message 358c toward the opposite end point of P1. It will be noted that the preempted indicator in P1 (associated with P2) is set and unset by NE3, and as such is locally controlled by the tandem NE3.

Concurrently NE5 has completed its cross-connect, and has received a bridged reply 360a from the responding end of P2. The bridged reply 360a indicates that the responding end NE has bridged traffic from W2 to P2, and all the tandem NEs of the responding end have completed the respective cross-connects. Accordingly NE5 forwards the bridged reply 360b to NE3. NE3 must wait until it has completed the cross-connect to erect P2, before it can relay the bridged reply 360c toward the requesting end.

At the opposite end point of P1, the preempted, bridged and switched message 356 was received, and consequently the selection of the working tunnel was applied. The opposite end point then issued a cede bridged message 362 which indicates that the opposite end point has deselected P1. The cede, bridged message is forwarded immediately by all of the NEs of P1, (to NE2 (362a), and to NE3 (362b)) except NE2, which sets the preempt indicator before forwarding the preempted, bridged message 362c to NE1. In accordance with an alternative embodiment, NE2 does not set the pre-empted indicator in the bridged message, and the NE3 assumes responsibility for pre-emption of the tunnel. In such alternative embodiments, failure of the NE3 to issue the pre-empted, bridged and switched message 358a prior to the forwarding of the reply 352c results in both NE2 and NE3 setting the pre-empted indicators.

On receipt of the preempted, bridged message, NE1 is notified that the opposite end point NE has selected W1. NE1 then begins taking down the bridge to W1, which will therefore not impact the traffic. On conclusion of the release of a local tunnel segment of P1, NE1 issues an idle message 364a to NE3. NE3 continues to set the preempted indicator until the idle messages are received from both directions on P1, and accordingly, once NE3 has released the next tunnel segment in P1, it sends a preempted idle messages 364b to NE2. The preempted idle message 364c is forwarded thereafter to the opposite NE. While the taking down of the cross-connects on P1 is taking place, NE2 receives a bridged message 366a from the requesting side of P2. As the cross-connect for P1 has just been taken down, the NE2 waits until the cross-connect for P2 is built before forwarding the bridged message toward the responding side.

In an alternative embodiment, the cross-connects at NEs2,3 are built for P2 immediately after the taking down of the cross-connects for P1. As long as an NE has seen bridged messages in both directions, building the cross-connect for a preempting tunnel may be allowed without affecting traffic. However, in accordance with the illustrated embodiment, the NEs wait until a confirmation is received from the end point NEs of the preempted tunnel before the cross-connects are built.

The opposite end point NE received the preempted, bridged message 358c, and like NE1, took down its bridge to the working tunnel. After all of the tandem NEs in P1 between NE2 and the opposite end point NE have relinquished respective tunnel segments, the idle message 368a is relayed to NE2. NE2 now begins building its cross-connect, as it has confirmation from both ends that the tunnel has been relinquished. The NE forwards the idle message 368b to NE3, which now removes the preemption indicator; relays the idle message 368c to NE1; and begins building the cross-connect for P2. As the preemption indicator on P1 at NE3 has been removed, the state of the tunnel segment of P1 on link 12b has changed. Accordingly an idle message 370a removing the preempted indicator is sent to NE2, and relayed toward the opposite end point NE (370b). NE3 also begins building the cross-connect for P2.

NE3 completes its cross-connect first and therefore issues the bridged reply 360c to NE2. When NE3 completes it's cross-connect it therefore relays the bridged reply 360d to the requesting side of P2, and the bridged message 366b to NE3. NE3 forwards the bridged message 366c to NE5, which in turn relays the bridged message 366c to the responding side of P2. As all of the tandem NEs on the responding side and the requesting side of P2 have already completed their respective cross-connects, the bridged replies 360, and bridged messages 366 are thereafter forwarded without delay.

When the end point NEs receive the bridged message 366, and the bridged reply, they select P2, and return a bridged and switched message 374 and a bridged and switched reply 372, respectively. The bridged and switched reply 372a is received from the responding side at NE5, forwarded to NE3 (372b), and then to NE2 (372c), and is then sent toward the requesting end NE (372d). The bridged and switched message 374a is received from the requesting side at NE2, forwarded to NE3 (374b), to NE5 (374c), and is then toward the responding side (374d).

FIG. 9 shows principal steps involved in an unsuccessful protection switch request from W1 to P1. Initially the network may be in a state where P2 is bridged and switched, and consequently occupies the data transport capacity shared with P1. The same sequence of messages also fits a scenario where a lockout of protection has been issued to NE3 with regard to the data transport capacity reserved by P1 and P2 by network management, except in that scenario no tunnel could be occupying the data transport capacity. In both cases the occupant priority of P2 is at least as great as the request priority (signal failure) on P1, and the occupant is therefore not ceded.

A now familiar failure sequence prompts the protection switch request as follows: a RDI 380 is detected by NE2, prompting NE2 to issue a tunnel condition message 382 to W1's end point, NE1. A reply to the tunnel condition 384a is sent by NE1, and is forwarded (384b) unsuccessfully to a next NE in W1. NE1 then identifies the protection tunnel segment reserved by W1, and determines the occupant priority of the data transport capacity on link 12d that supports this tunnel segment. The data transport capacity is idle, and accordingly the request is allowed. The NE1 therefore issues the switch request 386a over the identified link 12d, and begins building a bridge to the working tunnel W1.

Upon receipt of the switch request 386a, NE3 identifies an occupant priority the data transport capacity, and finds that the occupant priority is equal to or higher than that of the request. Accordingly NE3 sets the pended indicator, and forwards the pended request 386b to NE2, which, in turn, relays the pended request 386b to the opposite (to NE1) end point of P1.

The bridge to W1 at NE1 is completed and consequently a bridged message 388 is forwarded to NE3, before a switch request message is returned to NE2 from the opposite end of P1. When the switch request message is received from the opposite end, it is pended by NE2 which issues request 390b. The pended request 390a may have also been pended by an NE on the opposite side. The pended request 390b is forwarded to NE3, and from there to NE1 (390c). On receipt of the pended request 390c, NE1 takes down the bridge to W1. When the bridge is released, the state of the tunnel segment on link 12d has changed, and accordingly an idle message 392 is forwarded to NE3. As the NE3 has set the pended indicator, it inserts the pended indicator in the messages to the adjacent NEs of P1. The pended indicator is therefore set in the idle message 392 and this does not constitute a change from the last message sent (386b), accordingly the message need not be forwarded to NE2.

The pended condition lasts until the data transport capacity on link 12b is released. If the switch request had been a network management initiated request that was pended, end point issuing the request then may be provisioned to leave the request pending, or to remove the request and issue a refusal back to network management that issued the request.

The invention has been described with respect to a particular embodiment that overcomes the problems associated with providing the occupancy information where it is needed to make a preemption/pending decision, by distributing the information and maintaining respective information at respective NEs in the tunnel. The local information is only available at individual tandem NEs but is used by all the NEs together as required to decide on the allowability of protection switch requests. Advantageously, the method does not require the transmission of the local information to the end points of the tunnel, as such information would congest the network and make it difficult to provide the information, when required, in a timely manner.

The embodiments of the invention described above are intended to be exemplary only. The scope of the invention is therefore intended to be limited solely by the scope of the appended claims.

1. A network element (NE) of a data transport network across which a tunnel is provisioned, the NE comprising:
a signal processor for maintaining a local occupancy status of a tunnel segment of the tunnel adjacent the NE, the signal processor adapted to use the local occupancy status and content of protection switch messages received from adjacent NEs of the tunnel to control use of data transport capacity over a link that locally supports the tunnel segment, and communicates the use of the data transport capacity to adjacent NEs of the tunnel, in protection switch messages; and
a messaging system for exchanging the protection switch messages with adjacent NEs of the tunnel enabling distributed processing of the protection switch messages across the tunnel.

2. The NE as claimed in claim 1 wherein the tunnel is a bidirectional tunnel, and the messaging system is a full-duplex messaging system that transmits the protection switch messages on two bidirectional links, if the NE is a tandem of the tunnel, and on one bidirectional link if the NE is an end point of the tunnel.

3. The NE as claimed in claim 2 wherein the signal processor is further adapted to monitor each bidirectional link, and to relay a tunnel condition protection switch message in an opposite direction of a detected link condition, if a link condition is detected at the NE, and the NE is a tandem.

4. The NE as claimed in claim 3 wherein the messaging system comprises, for each of the bidirectional links, paired frame reception hardware and frame transmission hardware for processing consecutive frames of data transported over the bidirectional link, and the messaging system is provided by an automatic protection switch (APS) overhead of the frames that is presented to the signal processor with expedited interrupt-based handling.

5. The NE as claimed in claim 4 wherein the signal processor is adapted to control the use of the data transport capacity by inserting pended and preempted indicators in the APS messages, which originate at end points of the tunnel.

6. The NE as claimed in claim 5 wherein the signal processor is adapted to pend a received switch request if a current occupancy of one of the tunnel segments over which the switch request is transmitted is of an equal or higher priority than a request priority contained in the switch request.

7. The NE as claimed in claim 5 wherein if the tunnel passing through the NE is transporting live traffic, and a request of a higher priority is received from another tunnel for the data transport capacity of one of the tunnel segments of the tunnel, the NE initiates a preemption of the tunnel by inserting the preempted indicator into the APS messages in both directions.

8. A method for processing automatic protection switch (APS) messages at a network element (NE) in a tunnel provisioned across a data transport network, the method comprising:
determining whether the NE is an end point of the tunnel, or a tandem of the tunnel, when a new APS message is received at the NE;
if the NE is a tandem, applying a message handling procedure for the new APS message using local information about tunnel segments of the tunnel only maintained by the NE, to update the local information, and to selectively forward the updated information to adjacent NEs of the tunnel; and
if the NE is an end point, updating a status of the tunnel.

9. The method as claimed in claim 8 further comprising:
receiving a notice of a link condition on a link of the NE supporting one of the tunnel segments, and, if the NE is a tandem of the tunnel, originating a tunnel condition message used to indicate the link condition to the tunnel end point, so that a protection switch may be initiated;
receiving a tunnel status message from an adjacent NE in the tunnel from a K-byte overhead of a frame that serves as a data transport unit of the network; and
receiving a message from a network management that prompts a protection switch, if the NE is an end point of the tunnel.

10. The method as claimed in claim 9 wherein if the link condition is a signal degrade on a working tunnel, the originating the tunnel condition further comprises:
forwarding a tunnel condition message in the K-byte overhead to both adjacent NEs in the tunnel;
waiting for a reply to the tunnel condition messages from the end points of the tunnel via the adjacent NEs; and
receiving without forwarding the tunnel condition replies until the signal degrade link condition ends.

11. The method as claimed in claim 9 wherein receiving a tunnel status message from an adjacent NE comprises receiving one of the following:
a protection switch request used to erect a protection tunnel; and
a cede message, or a preempt message used to release a protection tunnel.

12. The method as claimed in claim 11 wherein applying the message handling procedure upon receipt of a protection switch request message, comprises:
identifying an occupant priority of data transport capacity supporting the tunnel segments of the tunnel;
comparing the occupant priority with a priority contained in the protection switch request to determine whether the protection switch is locally allowable;
forwarding the protection switch request over the tunnel segment if the protection switch is locally allowable; and
forwarding a pended protection switch request over the tunnel segment if the protection switch is locally not allowable

13. The method as claimed in claim 12 wherein comparing the occupant priority with the protection switch request priority comprises:
deeming the protection switch request allowed if the data transport capacity is unoccupied, and the occupant priority is consequently null;
deeming the protection switch request allowable if the occupant priority is less than the protection switch request priority; and
deeming the protection switch request not allowable if the occupant priority is greater than or equal to the protection switch request priority.

14. The method as claimed in claim 13 wherein the tunnel is a bidirectional tunnel, and the receiving the protection switch request comprises receiving the protection switch request from an adjacent NE in a first direction of the tunnel, removing any occupant, and building the cross-connect if the protection switch request is allowable, and an unpended switch request is received from the tunnel, in a direction opposite the first direction.

15. The method as claimed in claim 14 further comprising building the cross-connect as soon as the switch request is deemed allowed, and if the switch request received from the opposite direction is pended, taking down the cross-connect.

16. A method for processing a protection switch request at a network element (NE) in a tunnel provisioned across a data transport network, the method comprising:
receiving the protection switch request, and determining whether the NE is an end point of the tunnel, or a tandem of the tunnel; and
if the NE is a tandem, using an occupancy status of a tunnel segment of the tunnel only maintained by the NE, and a priority of the protection switch request to determine whether the protection switch is locally allowable; forwarding the protection switch request over the tunnel segment if the protection switch is locally allowable; and forwarding a pended protection switch request over the tunnel segment if the protection switch is locally not allowable.

17. The method as claimed in claim 16 further comprising maintaining the occupancy status by storing information related to whether data transport capacity that supports tunnel segments of the tunnel is idle, or a tunnel segment of an occupant tunnel is switch connected to another tunnel segment, and uses the data transport capacity; an occupant priority of the occupant tunnel; a link condition of a link providing the data transport capacity; and whether the NE is preempting the occupant tunnel, or pending the protection switch request.

18. The method as claimed in claim 17 wherein the determining whether the protection switch request is locally allowable comprises:
comparing the priority contained in the protection switch request with the occupant priority;
deeming the protection switch request allowed if the data transport capacity is unoccupied;
deeming the protection switch request allowable if the occupant priority is less than the protection switch request priority; and
deeming the protection switch request not allowable if the occupant priority is greater than or equal to the protection switch request priority.

19. The method as claimed in claim 18 wherein the tunnel is a bidirectional tunnel, and the receiving the protection switch request message comprises receiving the protection switch request from an adjacent NE in a first direction of the tunnel, preempting the current occupant, and building the cross-connect if the protection switch request is allowable, and an unpended switch request is received from the tunnel, in a direction opposite the first direction.

20. The method as claimed in claim 19 further comprising building the cross-connect as soon as the switch request is deemed allowed, and if the switch request received from the opposite direction is pended, taking down the cross-connect.
